(19) United States
(12) Patent Application Publication
(10) Pub. No.: US 2008/0136297 A1
(43) Pub. Date: Jun. 12, 2008

(54) Hinge with buffer function

(76) Inventor: Shan-Ping Huang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/543,044

(22) Filed: Oct. 5, 2006

(51) Int. Cl. E05B 65/46

(52) U.S. Cl. 312/219

(57) ABSTRACT

A hinge pivots a cover to a base of an object, and consists of a sleeve, an acting counteraction bar, a passive counteraction bar, and an oil hydraulic member; the acting counteraction bar has a connecting section, and a slope section, and is fitted in one end of the sleeve, and joined to the cover at the connecting section; the passive counteraction bar has a slope section, and is held in the sleeve in a linearly slidable manner with its slope section touching the slope section of the acting counteraction bar; the hydraulic member has an acting end, and is pressed against other end of the passive counteraction bar; when the cover is being pivoted open, the slope section of the acting bar will slide on the slope section of the passive bar to push the passive bar for the hydraulic member to slow down the acting bar.

### BACKGROUND OF THE INVENTION

1. Field of the Invention

The present invention relates to a hinge with buffer function, more particularly one, which will prevent a pivotal cover from moving too fast and shaking violently to get damaged when the cover is pivoted open.

2. Brief Description of the Prior Art

Hinges are used on a wide variety of devices, e.g. laptops, cellular phones with pivotal covers, and wastebaskets.

A conventional hinge consists of two plate-shaped members, and a pivotal rod-shaped part; the plate-shaped members are each bent so as to have a hollow cylindrical portion at an edge, and the pivotal rod-shaped part is passed through both the hollow cylindrical portions of the plate-shaped members. In use, the plate-shaped members are securely joined to a cover, and a base of a device respectively; thus, the cover is pivoted on the base, and will be kept at a certain angle after it is pivoted open. Other kinds of hinges have been developed for suiting different purposes and providing people with convenience, e.g. those that will return to a certain position automatically, those with a maximum open angle, and those that can be adjusted in its maximum open angle. However, currently existing hinges usually don't have buffer function; a cover of such a device, which is equipped with a hinge without buffer function, will move too fast and shake violently if too much force is exerted on the cover to pivot it open. Consequently, the cover is prone to get damaged.

### SUMMARY OF THE INVENTION

It is a main object of the invention to provide a hinge with buffer function to overcome the above-mentioned problems.

The hinge of the present invention is joined to a base of an object at two ends thereof, and pivots a cover to the base, and consists of a sleeve, an acting counteraction bar, a passive counteraction bar, and an oil hydraulic member. The acting counteraction bar has a connecting section, and a slope section, and is fitted in one end of the sleeve, and joined to the cover at the connecting section. The passive counteraction bar has a slope section, and is held in the sleeve in a linearly slidable manner with its slope section touching the slope section of the acting counteraction bar. The hydraulic member has an acting end, and is pressed against other end of the passive counteraction bar. Therefore, when the cover is being pivoted open, the slope section of the acting counteraction bar will slide on the slope section of the passive counteraction bar to push the passive counteraction bar for the hydraulic member to slow down the acting bar, thus preventing the cover from moving too fast and shaking violently to get damaged if the user exerts too much force on the cover.

### BRIEF DESCRIPTION OF THE DRAWINGS

The present invention will be better understood by referring to the accompanying drawings, wherein:

FIG. 1 is a perspective view of an object with the hinge of the present invention,

FIG. 2 is an exploded perspective view of the present invention,

FIG. 3 is a cross-sectional view of the present invention,

FIG. 4 is view for showing use of the present invention (1), and

FIG. 5 is view for showing use of the present invention (2).

### DETAILED DESCRIPTION OF THE PREFERRED EMBODIMENTS

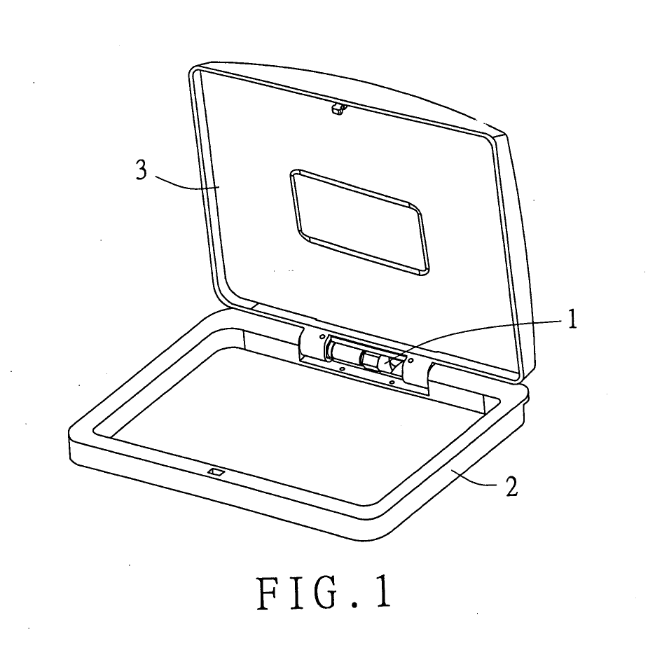

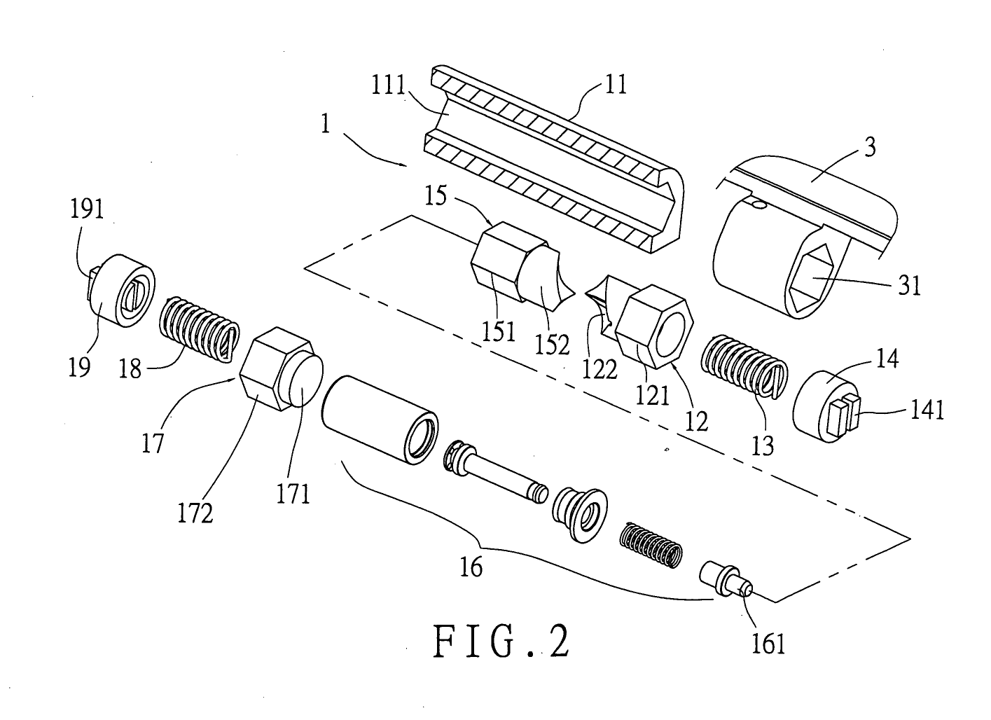

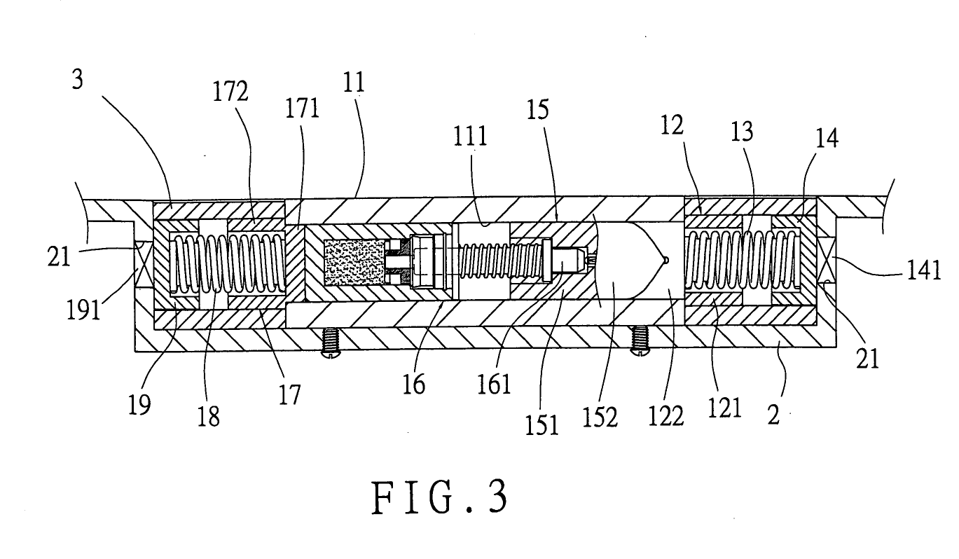

Referring to FIGS. 1 to 3, a preferred embodiment 1 of a hinge with buffer function is provided, which is joined to a base 2 of an object at two ends thereof, and pivots a cover 3 of the object to the base 2, and which consists of:

a sleeve 11, the sleeve 11 has a lengthways extending polygonal axial hole 111;

an acting counteraction bar 12, the acting counteraction bar 12 has a polygonal connecting section 121 having the same polygonal shape as the lengthways extending axial hole 111 of the sleeve 11, and a slope section 122, which has a sloping side thereon; the polygonal connecting section 121 is fitted in one end of the polygonal axial hole 111 of the sleeve 11 and a first polygonal hole 31 of the cover 3;

a first elastic element 13, the first elastic element 13 is securely joined to the polygonal connecting section 121 of the acting counteraction bar 12 at one end;

a first adjusting bar 14 securely joined to the other end of the first elastic element 13; the adjusting bar 14 has a polygonal engaging section 141, and is fitted in a first polygonal hole 21 of the base 2 at the polygonal engaging section 141 so that it can't be turned relative to the base 2;

a passive counteraction bar 15, the passive counteraction bar 15 has a polygonal section 151 having the same polygonal shape as the lengthways extending axial hole 111 of the sleeve 11, and a slope section 152, which has a sloping side thereon; the passive counteraction bar 15 is fitted and linearly slidable in the other end of the polygonal axial hole 111 of the sleeve 11, with the slope section 152 thereof touching the slope section 122 of the acting counteraction bar 12;

an oil hydraulic member 16, the oil hydraulic member 16 has an acting end 161, against which a tail end of the polygonal section 151 of the passive counteraction bar 15 is pressed;

a rotating bar 17, the rotating bar 17 has an insertion section 171, and a polygonal connecting section 172; the insertion section 171 of the rotating bar 17 is held in the other end of the polygonal axial hole 111 of the sleeve 11; the polygonal connecting section 172 of the rotating bar 17 is fitted in a second polygonal hole 31 of the cover 3;

a second elastic element 18, the second elastic element 18 is securely joined to the polygonal connecting section 172 of the rotating bar 17 at one end thereof; and

a second adjusting bar 19, the second adjusting bar 19 is securely joined to the other end of the second elastic element 18; the second adjusting bar 19 has a polygonal engaging section 191, and is fitted in a second polygonal hole 21 of the base 2 at the polygonal engaging section 191 thereof such that the second adjusting bar 19 can't be turned relative to the base 2.

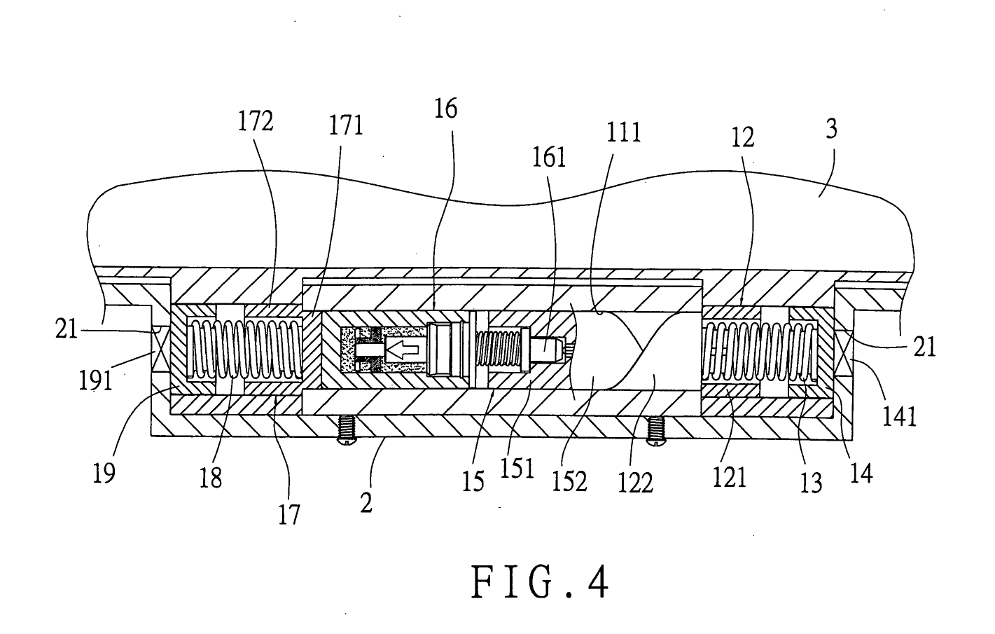

Referring to FIGS. 1 to 4, when the user is exerting force to pivot the cover 3 towards the open position, the cover 3 will cause rotational motion of the acting counteraction bar 12, and the slope section 122 of the acting counteraction bar 12 will make the passive counteraction bar 15 move further away from the acting counteraction bar 12 and push the acting end 161 of the oil hydraulic member 16 with an uppermost point of the slope section 122 sliding from a lowermost portion of the slope section 152 of the passive counteraction bar 15 to an uppermost portion of the slope section 152; thus, the oil hydraulic member 16 reduces speed of linear displacement of the passive counteraction bar 15. Consequently, pivotal motion of the acting counteraction bar 12 and the cover 3 is reduced. And, the cover 3 is prevented from moving to its open position too fast and shaking violently.

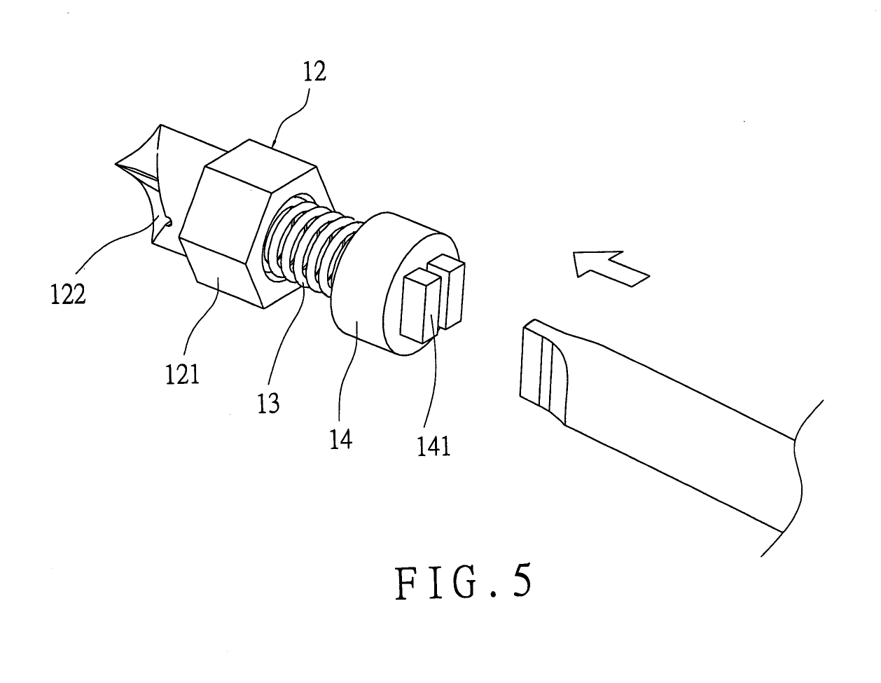

Furthermore, referring to FIG. 5, after the adjusting bars 14 and 19 are separated from the holes 31 of the base 2, they are turned so as to tighten the elastic elements 13 and 18 by means of a tool; thus, when the cover 3 is being pivoted to the open position, the elastic elements 13 and 18 will reduce rotational speed of the acting counteraction bar 12 and the rotating bar 17, and the speed of pivotal motion of the cover 3 is further reduced.

From the above description, it can be seen that the present invention has the following advantages:

1. When the hinge of the present invention is used on an object that consists of a base, and a pivotal cover on the base, it can help reduce the speed of pivotal motion of the cover, thus preventing the cover from moving too fast and shaking violently to get damaged if the user exerts too much force on the cover.

2. When the cover is being pivoted to its open position, the acting counteraction bar will touch and slide on the slope section of the passive counteraction bar at the slope section thereof, and in turn the passive counteraction bar will push the acting end of the oil hydraulic member; thus, the oil hydraulic member will slow down rotational motion of the acting counteraction bar, thus making the cover pivot on the base at a relatively low and steady speed.

3. The hinge can further reduce the speed of pivotal motion of the cover after the user tightens the elastic elements, which are fitted between the first adjusting bar and the acting counteraction bar, and between the rotating bar and the second adjusting bar respectively, by means of angularly displacing the adjusting bars.

What is claimed is:

1. A hinge with buffer function,
the hinge being joined to a base of an object at two ends thereof, and pivoting a cover of the object to the base, and comprising
a sleeve, the sleeve having a lengthways extending axial hole;
an acting counteraction bar fitted in one end of the axial hole of the sleeve, the acting counteraction bar having a connecting section, and a slope section; the acting counteraction bar being joined to the cover of the object at the connecting section thereof;
a passive counteraction bar, the passive counteraction bar being held in the axial hole of the sleeve in a linearly slidable manner, the passive counteraction bar having a slope section at one end thereof; the acting counteraction bar touching the slope section of the passive counteraction bar at the slope section thereof; and
an oil hydraulic member having an acting end, the acting end of the oil hydraulic member being pressed against other end of the passive counteraction bar.

2. The hinge with buffer function as recited in claim 1, wherein the lengthways extending axial hole of the sleeve is polygonal, and the passive counteraction bar has a polygonal section, which has a same polygonal shape as the lengthways extending axial hole of the sleeve.

3. The hinge with buffer function as recited in claim 1, wherein the connecting section of the acting counteraction bar is polygonal, and the cover has a polygonal hole having a same shape as the polygonal connecting section of the acting counteraction bar, and the acting counteraction bar is fitted in the polygonal hole of the cover at the polygonal connecting section.

4. The hinge with buffer function as recited in claim 1 further having an elastic element, and an adjusting bar; the elastic element being securely joined to the connecting section of the acting counteraction bar at one end, and securely joined to the adjusting bar at other end thereof; the adjusting bar having an engaging section, and engaging the base at the engaging section.

5. The hinge with buffer function as recited in claim 1 further having a rotating bar, an elastic element, and an adjusting bar; the rotating bar being joined to the cover; the rotating bar having an insertion section held in other end of the sleeve; the elastic element being securely joined to the rotating bar at one end, and securely joined to the adjusting bar at other end thereof; the adjusting bar having an engaging section, and engaging the base at the engaging section.

6. The hinge with buffer function as recited in claim 4, wherein the engaging section of the adjusting bar is polygonal, and is fitted in a hole of the base, which hole has a same shape as the polygonal engaging section of the adjusting bar.

7. The hinge with buffer function as recited in claim 5, wherein the engaging section of the adjusting bar is polygonal, and is fitted in a hole of the base, which hole has a same shape as the polygonal engaging section of the adjusting bar.
